(19) United States
(12) Patent Application Publication
(10) Pub. No.: US 2026/0100942 A1
(43) Pub. Date: Apr. 9, 2026

(54) MEDIA STREAMING SYSTEM AND METHOD FOR ENTITLEMENT VERIFICATION AND USER AUTHENTICATION

(71) Applicant: DISH Network Technologies India Private Limited, Bengaluru (IN)

(72) Inventor: Sagar Sehgal, Bengaluru (IN)

(21) Appl. No.: 18/951,797

(22) Filed: Nov. 19, 2024

(30) Foreign Application Priority Data
Oct. 4, 2024 (IN) 202441075251

(51) Int. Cl. H04L 9/40; G06F 21/10; G06F 21/62

(52) U.S. Cl. CPC H04L 63/0807; G06F 21/1014; G06F 21/6209

(57) ABSTRACT

Systems, devices, and methods related to user authentication for media streaming are provided. An example computing system includes one or more processors and a computer-readable storage media including instructions that, when executed by the one or more processors, cause the computing system to receive a request for content from an application executed on a user device, the request including user authentication information. The instructions when executed further cause the computing system to verify the user device based on the user authentication information, generate a token including user authentication information, generate a manifest file associated with the content and transmit the manifest file and the token to the application executed on the user device. The instructions when executed further cause the computing system to encrypt the user authentication information using a public key of a public-private key pair such that the user authentication information is obfuscated.

### CROSS REFERENCE TO RELATED APPLICATIONS

This application claims priority to Indian Provisional Patent Application Serial No. 202441075251 filed on Oct. 4, 2024, in the Indian Intellectual Property Office, the disclosure of which is incorporated by reference in its entirety for all purposes.

### BACKGROUND

User authentication is used in content delivery and streaming services to ensure that content is delivered securely and only to authorized users. User authentication is typically performed by content providers to verify the identity of a user before granting the user access to the content.

### SUMMARY

In accordance with some embodiments of the present disclosure, a computing system is provided. The computing system may be a streaming service provider system for providing streaming services to user devices associated with the streaming service provider. In one example, the computing system includes one or more processors and a computer-readable storage media comprising instructions. The instructions when executed by the one or more processors cause the computing system to receive, by the computing system, a request for content from an application executed on a user device. The request includes user authentication information. The instructions when executed further cause the computing system to verify the user device based at least in part on the user authentication information, generate a token including user authentication information, generate a manifest file associated with the content, and transmit the manifest file and the token to the application executed on the user device.

In some embodiments, the application on executed on user device transmits the token to a content provider associated with the content.

In some embodiments, the application executed on the user device receives a decryption key generated by the content provider and accesses the content using the decryption key.

In some embodiments, the decryption key is received by the application executed on the user device as a secured blob generated by the content provider.

In some embodiments, the instructions when executed further cause the computing system to encrypt the user authentication information using a public key of a public-private key pair such that the user authentication information is obfuscated.

In some embodiments, the instructions when executed further cause the computing system to store the user authentication information in a database, assign a hashed value to the user authentication information, generate the token based at least in part on the hashed value, and provide access to the user authentication information to the content provider based at least in part on the hashed value.

In accordance with some embodiments of the present disclosure, a method is provided. In one example, a method includes receiving, by a computing system, a request for content from an application executed on a user device, the request including user authentication information. The method further includes verifying, by the computing system, the user device based at least in part on the user authentication information, generating, by the computing system, a token including user authentication information, generating, by the computing system, a manifest file associated with the content, and transmitting, by the computing system, the manifest file and the token to the application executed on the user device.

In another example, a method includes receiving, in a first authentication server of a streaming service provider, a request for streaming content on a user device. The request is transmitted from an application executed on the user device. The request identifies the content and includes user authentication information. The method further includes performing entitlement verification, by the first authentication server, based at least in part on the user authentication information. The method further includes generating, by the first authentication server, a token including obfuscated user authentication information of the user authentication information. The method further includes transmitting, by the application executed on the user device, the token to a second authentication server of the content provider. The method further includes generating, by a dynamic manifest generation server of the streaming service provider, manifest files associated with the content. The method further includes transmitting the manifest files, by the dynamic manifest generation server, to the user device after the entitlement verification is performed.

In yet another example, a method performed by an application executed on a user device includes transmitting, by the application, a first request for content to a computing system associated with the application, the first request including user authentication information. The method further includes receiving, by the application, a verification token from the computing system in response to the first request, the verification token indicating that the user has been verified by the computing system. The method further includes receiving, by the application, a manifest file associated with the content from the computing system, the manifest file identifying one or more segments of the content. The method further includes transmitting, by the application and to a content provider associated with the content, a second request identifying one or more segments of the content and comprising the verification token. The method further includes receiving, by the application, the one or more segments of content identified in the second request and a decryption key. The method further includes accessing, by the application, the one or more segments of the content identified in the second request using the decryption key. In some embodiments, the verification token comprises obfuscated user authentication information corresponding to the user authentication information.

In some embodiments, the method further includes transmitting, by the application, a request for a manifest file associated with the content to the computing system, and receiving the manifest file from the computing system. The method further includes transmitting, by the application, a request for content according to the manifest file to the content provider, and receive one or more segments of the content from the content provider. The method further includes rendering, by the application, the one or more segments of the content for playback.

In accordance with some embodiments of the present disclosure, a user device is provided. In one example, the user device includes: one or more processors and a computer-readable storage media storing computer-executable instructions. The computer-executable instructions, when executed by the one or more processors, cause the user device to transmit, by the application, a first request for content to a computing system associated with the application, the first request including user authentication information. The computer-executable instructions when executed further cause the user device to receive, by the application, a verification token from the computing system in response to the first request, the verification token indicating that the user has been verified by the computing system. The computer-executable instructions when executed further cause the user device to receive, by the application, a manifest file associated with the content from the computing system, the manifest file identifying one or more segments of the content. The computer-executable instructions when executed further cause the user device to transmit, by the application and to a content provider associated with the content, a second request identifying one or more segments of the content and comprising the verification token. The computer-executable instructions when executed further cause the user device to receive, by the application, the one or more segments of content identified in the second request and a decryption key. The computer-executable instructions when executed further cause the user device to access, by the application, the one or more segments of the content identified in the second request using the decryption key.

In accordance with some embodiments, the present disclosure also provides a non-transitory machine-readable storage medium encoded with instructions, the instructions executable to cause one or more electronic processors of a computing system or a user device to perform any one of the methods described in the present disclosure.

### BRIEF DESCRIPTION OF THE DRAWINGS

FIG. 1 is a block diagram illustrating an example media streaming system, according to various embodiments of the present disclosure.

FIGS. 2A-2B are message flow diagrams respectively illustrating examples of interaction among components in the communications system of FIG. 1, according to various embodiments of the present disclosure.

FIGS. 3A-3C are flow diagrams respectively illustrating example methods for user authentication and streaming services, according to various embodiments of the present disclosure.

FIG. 4 illustrates an example computer system or computer device, according to various embodiments of the present disclosure.

### DETAILED DESCRIPTION

Media streaming services rely on security systems to manage user entitlements and allow authorized users to access to content. Traditionally, entitlement verification in content streaming services is performed by content providers and includes extensive user information directly into the transaction headers of requests for content. This embedded data typically includes user IDs, subscription details, device information, and other sensitive data necessary for validating a user's right to access specific content. When a user attempts to access content, the content provider extracts and processes this information to determine whether the user is entitled to access the content. However, the traditional method of embedding sensitive user information in transaction headers presents security challenges. Exposing detailed user information in transaction headers may increase the risk of data leakage, interception, and exploitation by malicious actors during transmission to the content provider.

The present disclosure provides techniques for addressing at least the above-mentioned challenges. One insight provided herein is related to a media streaming system that enhances security and efficiency in delivering content to authorized users. According to some embodiments of the present disclosure, the media streaming system includes a streaming service provider with a first authentication server and a dynamic manifest generation server, and a content provider with a second authentication server. The first authentication server of the streaming service provider receives a streaming request from a user device, performs entitlement verification using the user's original authentication information, generates a token with obfuscated user details, and sends the token to the second authentication server of the content provider. The dynamic manifest generation server generates and sends manifest files to the user device once entitlement verification is completed to allow the user device to fetch the encrypted content segments of the content item according to the manifest files. The second authentication server at the content provider decrypts the token to retrieve the original user information, performs further authentication, and, if the user is authorized, provides the user device with a decryption key for the encrypted content.

The media streaming system and the related method of the present disclosure provides at least the following advantages. By generating a token with obfuscated user authentication information, the system ensures that sensitive user data is not exposed during transmission. This reduces the risk of data interception and unauthorized access. Entitlement verification is performed internally within the streaming service provider before any data is sent to the content provider. This adds an extra layer of security and reduce the risk of exposure and spoofing attacks. The tokenization process further enhances the protection of sensitive user information. Even if the token is intercepted, it cannot be used to spoof or gain unauthorized access, as the original user information is not directly exposed.

Additionally, the streaming service provider performs entitlement verification (i.e., verify the user device) internally and sends manifest files directly to the user device after entitlement verification, which could reduce the number of steps or the wait time required for authentication of the user device by the content provider and lead to a faster and more efficient user experience. The present method also provides a layered approach to access control where both the streaming service provider and the content provider perform their respective verifications/authentications, which could enhance the overall security.

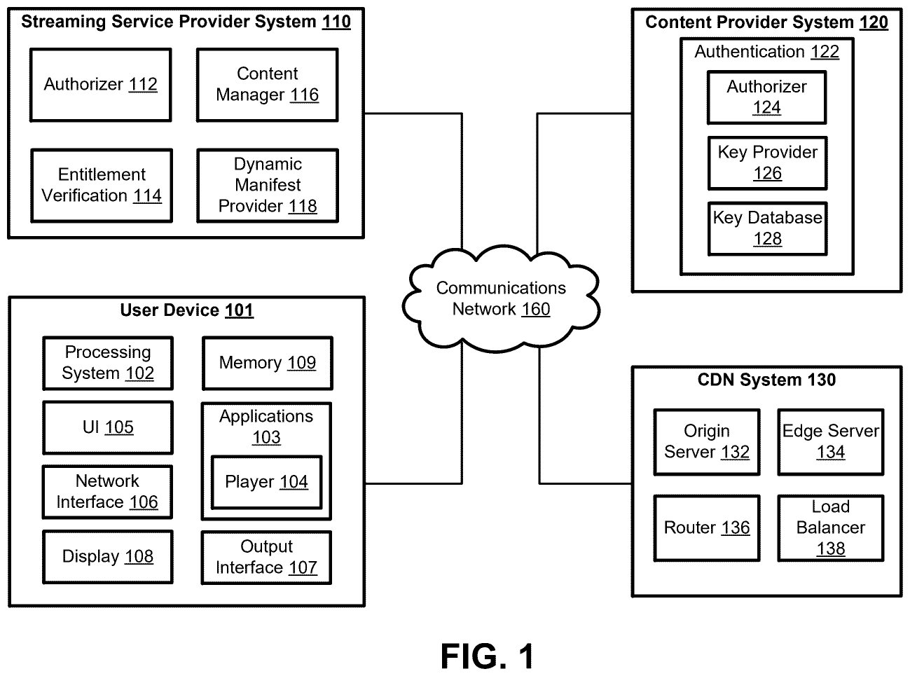

FIG. 1 is a block diagram illustrating an example media streaming system 100 (hereinafter “system 100”) for providing media streaming services, authenticating users, and protecting user information, according to various embodiments of the present disclosure. In the illustrated example, media streaming system 100 includes, among other components, user device 101, streaming service provider or system 110, content provider or content provider system 120, content delivery network (CDN) system 130, and communications network 160. Each component included in the media streaming system 100 may encompass a hardware piece such as a computer device/system or a server, a software piece such as a service, a cloud-based service, and an application, or a combination of hardware and software. Additional components may be included in the media streaming system 100, such as an advertisement (Ad) server, an Ad provider system, etc.

System 100 may be operable to provide content streaming services using HLS (HTTP Live Streaming) protocols. HLS protocol is used to deliver audio and video content over the internet (e.g., communications network 160) in a way that allows for adaptive bitrate streaming (ABS). The quality of the stream can adjust dynamically based on the network conditions, device operating status, and/or other environment parameters. Other streaming protocols, such as Dynamic Adaptive Streaming over HTTP (DASH), Real-Time Messaging Protocol (RTMP), Common Media Application Format (CMAF), Web Real-Time Communication (WebRTC), are also possible for providing streaming services and are within the scope of the present disclosure.

The user device 101 may be a computerized device such as a smartphone, tablet, computer, smart TV, etc., operable to stream multimedia content. The “user device” used herein is interchangeable with “media streaming device” or an equivalent kind thereof. In some embodiments, the user device 101 includes, among other components, processing system 102, applications (e.g., “apps”) 103, user interface (UI) 105, network interface 106, output interface 107, display 108, and memory 109. The processing system 102 includes the CPU (Central Processing Unit) and other processing units that are responsible for executing various applications 103 and performing various computational tasks, including decoding multimedia content, managing streaming protocols, handling user interface interactions. The applications 103 are software programs stored in memory 109 and responsible for performing specific functions or provide certain features. The applications 103 include an application associated with or controllable by the streaming service provider 110. The application is executed on the user device 101 to cause the user device 101 to handle the communication with the streaming service provider 110 and content provider 120. In some embodiments, the applications 103 include a media player application 104 (hereinafter “player 104”) playback of multimedia content such as main content of a content item or Ad content of an Ad. The player 104 may be integrated with the UI 105 and present controls and visual feedback on the display 108 for user interaction.

The player 104 may be a product of a player software development kit (SDK), which includes a set of software tools, libraries, and documentation. In some embodiments, player 104 may be designed to integrate with the content provider 120 to deliver a smooth streaming experience on the user device 101. For example, player may include media playback engine responsible for decoding and rendering multimedia content, video and audio synchronization, buffering, and playback controls, application programing interface (API) responsible for starting, pausing, stopping playback, seeking, and retrieving playback status, integration documentation responsible for providing guidelines for integrating player 104 into different platforms or applications, and so on. The player SDK is configured with the capability to play both multimedia content and Ads.

As used herein, “content” refers to any humanly perceptible information, such as video, television programs, audio programs, speeches, concerts, gaming, or otherwise. The content may originate from any source, including live, augmented reality, virtual reality, computer generated, or otherwise. The content may be presented to a given user using any desired user device such as the user device 101. The content may be presented to one or more users “real-time” (which is defined herein to mean as the underlying action provided in such content first occurs in time), on a recorded, time delayed, time shifted, or any other basis. “Main content” refers to the primary audio or video stream that users intend to watch or listen to during a streaming session. “Ad content”refers to the advertisements that are displayed during an Ad break session.

In some embodiments, the main content of a content item is a DRM-protected content. The DRM-protected content refers to digital media that is secured and managed using Digital Rights Management (DRM) technologies, which encompass a range of tools, protocols, and systems designed to protect digital content from unauthorized access and distribution. A content provider system provides DRM-protected content to authorized users who are granted licenses (e.g., decryption keys to the encrypted content) to access the DRM-protected content.

The player 104 may initiate a streaming session once triggered by a user interaction event (e.g., when user clicks a “play” button on the UI 105). A streaming session used herein refers to a continuous and time-bounded period during which a user engages with streaming content through a user device. In digital media streaming, such as video or audio streaming, a streaming session typically begins when a user initiates playback of the main content and ends when the user stops, terminates, or completes the streaming experience. During a streaming session, a user interacts with various content, including the main video or audio content, Ads, and potentially other related data.

The player 104 may send various requests to the streaming service provider system 110. The requests may include a request for content, a request for authentication/authorization, a request for Ad, etc. The request may include various user authentication information, including but not limited to user identity (ID), user credentials, user device identity (ID), user account information, user status information, subscription information, and other user information. In some embodiments, the user device ID is Globally Unique Identifier (GUI) preregistered with the service provider system 110.

The applications 103 may further include one or more applications when executed by the processing units to the cause the user device 101 to perform various functions such as communicating with other components of system 100, sending and receiving signals, messages, and data (e.g., update/status messages, token, decryption key, etc.), and other operations in conjunction with media streaming of player 104.

The UI 105 includes a graphical user interface (GUI) displayed on the display 108 and featuring playback controls (play, pause, rewind, etc.), navigation menus, a visually engaging display area, and various interactive elements for user interaction. In some embodiments, the UI 105 may integrate with various multimedia formats, supporting audio, video, and images, and offers playlist management for personalized content experiences. The UI 105 may provide interactive features that respond dynamically to touch gestures, mouse clicks, or remote control inputs. The UI 105 may interact with network interface 106 for online content streaming and may be configured to be responsive across different screen sizes.

Network interface 106 is configured to facilitate communication between the user device 101 and communications network 160, which can include the Internet and, possibly, various other public and/or private networks through which communication with user device 101 can be performed. The multimedia content can be streamed and received by user device 101. In some embodiments, the display 108 is an independent display device connected to the user device 101, for example, via output interface 107. The content output by the user device 101 may be presented by the display 108. In some embodiments, a remote control (not shown) may allow a user to provide input to user device 101 wirelessly through the UI 105.

The streaming service provider system 110 may be a backend server of the streaming service provider and include an authorizer 112, an entitlement verification component 114, a content manager 116, and a dynamic manifest provider or system 118. In some embodiments, the authorizer 112 and the entitlement verification component 114 are integrated as an authentication server of the streaming service provider 110.

The authorizer 112 is operable to receive and process a request for user authentication from a user device. In some embodiments, the authorizer 112 extracts various information from the request, including the user authentication information, user ID, user device ID, content information of the target content item requested by the user, among others. The authorizer 112 may determine whether the content requested by the user is a DRM-protected content and requires further authentication or authorization by the content provider system 120. The authorizer 112 may forward the user request and extracted information to other components within the streaming service provider system 110.

The entitlement verification component 114 may be a server, a device, a module, or a service operable to receive user information from the authorizer 112, perform entitlement verification, and authenticate the user based on the user authentication information within the streaming service provider system 110. Upon successful authentication and entitlement verification, the entitlement verification component 114 may generate a response indicating the user's authentication status and entitlements.

In some embodiments, the entitlement verification component 114 locates a preregistered user profile within a database of the streaming service provider system 110 based on the user identity and credential, analyzes the user's entitlements and access rights (e.g., subscription status, membership level, content access rights, geographic restrictions, etc., associated with the user's profile) stored in the user profile, and determines whether the user is entitled to access of the requested content. If the user meets the necessary entitlement criteria and has the required access rights, the entitlement verification component 114 grants authorization for content streaming. Conversely, if the user fails to meet the entitlement criteria or lacks the necessary access rights, the entitlement verification component 114 denies authorization for content access.

Since the entire entitlement verification process is conducted within the streaming service provider system 110, without transmitting user information outside of the system 110, the risk of spoofing or unauthorized access is significantly reduced. Moreover, upon successful entitlement verification within the streaming service provider system 110, the user device 101 can immediately begin requesting manifest files and fetching content segments, such as encrypted DRM-protected content segments, prior to or concurrently with the authentication by the content provider system 120. This can significantly reduce the lead time for streaming and improving user experience. Further, the entitlement verification process within the streaming service provider system 110 can serve as an additional access control mechanism, in additional to the authentication process by the content provider, to fortify the content against unauthorized access and distribution.

In some embodiments, the authorizer 112 is further operable to generate a token containing obfuscated user authentication information and send the token back to the user device 101, upon an indication of successful entitlement verification. In some embodiments, the authorizer 112 constructs a token structure that includes fields for essential user authentication information such as user ID, user credentials, user device ID, session ID, timestamp, and any additional metadata required for authentication or authorization by the content provider system 120 or an external/third-party content provider. A standardized token format or data structure (e.g., JSON Web Token (JWT), XML, or custom binary format) may be used by the authorizer 112 to organize the token data. The authorizer 112 may obfuscate sensitive user authentication information within the token, using a suitable cryptographic algorithm such as Advanced Encryption Standard (AES) or Rivest-Shamir-Adleman (RSA). In some embodiments, the authorizer 112 may perform data encryption and obfuscation by one or more of the following operations: encrypting user-specific data fields using a secret key or public-private key pair; applying obfuscation techniques to further obscure the token contents, sensitive user authentication information, and user-specific data fields; introducing random padding or noise within the token structure to mask the underlying data patterns and add entropy to the token; performing bitwise operations (e.g., XOR, bitwise shifting) on specific token fields to scramble the data and introduce variability. The authorizer 112 may finalize the obfuscated token, for example, by appending necessary metadata or validation information to the token, including a digital signature or a Hash-based Message Authentication Code (HMAC), and/or encoding the token using a standardized encoding scheme (e.g., Base64) for compatibility with the transport protocols or data formats used for transmission of the token to the content provider system 120.

The content manager 116 is generally responsible for the management of content, including DRM-protected content, as well as the management of user profiles, entitlements, and access rights within the streaming service provider system 110. The content manager 116 may further include a playlist generator and a stream controller.

The playlist generator is operable to generate a playlist file (also known as a “cliplist”) as a response to user requests. When a user request for the target content is received, typically specifying a particular content item for streaming and viewing, the playlist generator is activated. In response, the playlist generator creates a playlist file that outlines the sequence of content segments (also known as clip segments) associated with the specified content item. The playlist file serves as a structured guide for the streaming process and provide information on the order and characteristics of the content segments to be delivered to the user device 101. For example, if a user requests a specific video, the playlist generator would compile a playlist file that enumerates the individual video segments of the video. The playlist file may include details such as the identity and characteristics of each content segment to allow the streaming service to efficiently deliver the requested content item to the user.

The content segments specified in the playlist file can encompass both main content segments and Ad segments, and their sequence within the playlist file determines the order in which they are presented during a streaming session. The playlist file may contain sequence information indicating or identifying the position of each ad segment in relation to the main content, which is determined by preestablished Ad placement rules.

The stream controller is operable to generate a stream control file that organizes content segments in the sequence established by the playlist file within the streaming service provider system 110. The stream control file is used to control and orchestrate the streaming session and contains information about the arrangement and structure of the content segments, including segment durations, encoding settings, resolution, bitrates, and other technical specification and metadata necessary for the delivery and playback of content segments. The content manager 116 may generate a response including the playlist and the stream control file and transmit the response to the dynamic manifest provider system 118 and/or the user device 101.

The dynamic manifest provider system 118 is generally responsible for generating manifest files, managing manifest files, and transmitting the manifest files to the user device 101. In some embodiments, the dynamic manifest provider system 118 may further include a Uniform Resource Locator (URL) generator. The URL generator is operable to generate/obtain URLs for content segments (e.g., main content segments and/or Ad segments). In some embodiments, the URL generator 115 may generate URLs for the main content segments (i.e., content segment URLs) of the content item. For example, the content item is segmented into smaller, manageable portions or segments. These content segments could represent portions of a video, audio, or other multimedia content of the content item. Segmentation may be performed by the content provider system 120. Each content segment is assigned a unique identifier or name. The identifier distinguishes one segment from another and is used for creating distinct URLs. A base URL may be established, representing the root or common part of the URL for the entire content item. The base URL may include information such as the domain name and directory structure. The unique identifier assigned to each content segment is appended to the base URL to create a specific URL for each content segment and to allow the user device to locate and retrieve the content segment. In some embodiments, The URL generator may further apply URL encoding to handle special characters or spaces within the segment identifiers according to preestablished URL encoding rules. In some embodiments, each content segment may have a predetermined length representing a time duration, for example, 2 seconds, 5 seconds, etc. In a similar manner, the URL generator may also generate URLs for Ad segments (i.e., Ad segment URLs) of an Ad to-be-played in an Ad break session.

The dynamic manifest provider system 118 is operable to compile/integrate the playlist file, stream control file, and the generated URLs, and other pertinent metadata and information to generate manifest files. A manifest file used herein refers to a structured document that provides essential information about the organization, sequencing, and technical details of multimedia content to be delivered during a streaming session. Manifest files may have different types based on the streaming protocol used, such as HLS or DASH. Manifest files outline the structure and organization of the multimedia content, including the sequence of individual segments or chunks that make up the complete content item, contain URLs or references to the individual content segments to allow the user device 101 to dynamically fetch these segments during playback.

Manifest files include technical specifications such as bitrates, resolutions, codecs, and other encoding details for each content segment to guide the rendering process. For live streaming or linear channels, manifest files may also include playlist/cliplist information to specify the sequence and timing of upcoming content segments.

In some embodiments, the HLS streaming protocols are used, and the manifest file is an HLS manifest file. The HLS manifest file may encompass a master HLS manifest file (i.e., master manifest file) and a variant HLS manifest file (i.e., a variant manifest file). The master HLS manifest file is a high-level document that provides an overview of the available variants of the content and may include references or URLs to variant HLS manifest files, each representing a different version of the content at specific bitrates or resolutions. Variant HLS manifest files are more granular documents associated with specific bitrates, resolutions, or other metadata for streaming the content segments. These files contain detailed information about individual content segments, their URLs, and technical specifications. For example, each variant manifest file may correspond to a particular version of the content to allow for adaptive streaming where the user device can dynamically switch variants or play in a sequence to optimize playback based on changing network conditions.

In some embodiments, the rolling HLS variant manifest (also known as “chunked manifest” or “sliding window manifests”) may be generated. Rolling variant manifest files, in the context of HLS, refer to dynamic and periodically updated variant manifest files that outline the sequences and details of content segments for adaptive bitrate streaming. The rolling variant manifest files are generated at regular intervals, for example, every few seconds. Each rolling variant manifest file reflects the current state of the streaming session, including changes in network conditions and available content variants. Each rolling variant manifest file specifies the sequence of content segments associated with a particular time window. Each update introduces a new set of content segments and adjusts the temporal window to represent the most relevant portion of the streaming timeline. Consecutive updates of the rolling variant manifest files may include an overlap of content segments with the previous version. The overlap allows for smooth transitions during playback and continuous streaming without interruptions when the user device 101 switches between different content variants.

In some embodiments, the manifest files may be stored in a database of a storage server within the streaming service provider system 110. The manifest files can be retrieved or fetched by the user device 101. For example, the user device 101 may fetch the variant manifest file according to the associated URLs included in the master manifest file. The user device 101 may fetch content segments according to the associated URLs included in the variant manifest files and store the content segments in the memory 119.

The content provider system 120 may be operated by a third-party content provider independent from the streaming service provider. The content provider system 120 may include an authentication server 122. The authentication server 122 is different from the authorizer 112 and the entitlement verification component 114 of the streaming service provider system 110. The authentication server 122 is operable to perform user authentication and access authentication for DRM-protected content.

In some embodiments, the authentication server 122 further includes an authorizer 124, a key provider 126, and a key database 128. The authorizer 124 is a distinct server or device or module from the authorizer 112 included in the streaming service provider system 110. The authorizer 124 is operable to receive a request from the user device 101, such as a request for license to the DRM-protected content. The authorizer 124 is also operable to receive the token from the user device 101, analyze the token, extract original user authentication information (e.g., user ID, device ID, user credentials, etc.), and determine whether the user is entitled to the DRM-protected content based on the original user authentication information and predefined content access policies. As mentioned above, the token contains sensitive user information that has been obfuscated to protect sensitive user information during transmission from the user device 101 to the authorizer 124. If the user is authorized, the authorizer 124 is operable to coordinate with the key provider 126 to distribute the necessary decryption keys to the user device 101 to decrypt the encrypted content segments of the DRM-protected content requested by the user.

The key provider 126 is operable to generate, distribute, and manage encryption keys used to protect DRM content. Upon successful authorization of the user, the key provider 126 is operable to distribute one or more encryption keys to authorized user device 101 for decrypting DRM-protected content or the content segments thereof. The key provider 126 is also operable to handle key revocation and rotation to maintain the security and integrity of content access by the user device 101.

The key database 128 is operable to store the encryption keys and related metadata, enforce access controls to restrict unauthorized access to encryption keys, and allow the key provider 126 to fetch the encryption keys upon request.

The content delivery network (CDN) system 130 is generally responsible for optimizing the delivery and distribution of multimedia content to user device 101. The CDN system 130 may be an integral part of the network infrastructure of the media streaming system 100 and include an original content server 132, one or more edge content servers 134, routers 136, load balancers 138, among others. In some embodiments, the original content servers 132 may be included in the content provider system 120 for storing and hosting multimedia content, the edge content servers 134 are positioned closer to the user device 101 to cache and deliver content (e.g., DRM-protected content or content segments), the routers 136 are operable to manage the flow of data, and the load balancer 138 is operable to distribute traffic across servers to optimize content distribution and delivery as well as resource utilization.

Communications network 160 communicatively interconnects the various components of media streaming system 100. The communications network 160 may utilize any known and/or later arising communications and/or networking technologies, standards, protocols or otherwise. Non-limiting examples of such technologies include packet switch and circuit switched communications technologies, such as and without limitation, Wide Area Networks (WAN), such as the Internet, Local Area Networks (LAN), cellular communications networks such as a 3G/4G/5G/6G or other cellular network, Internet of Things (IoT) networks, cloud-based networks, private networks, public networks, or otherwise.

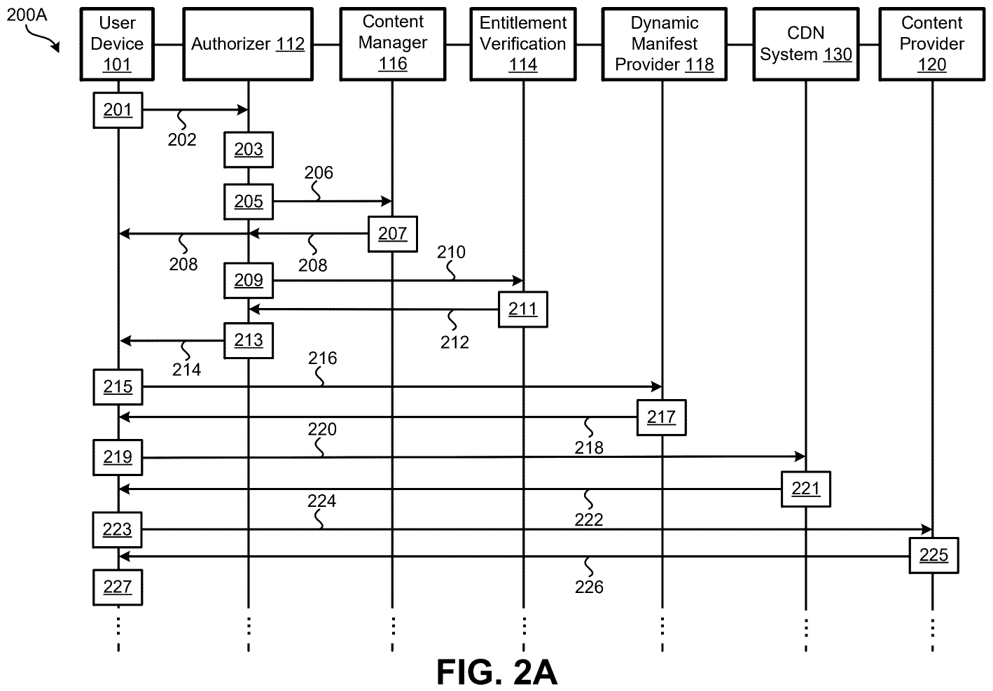

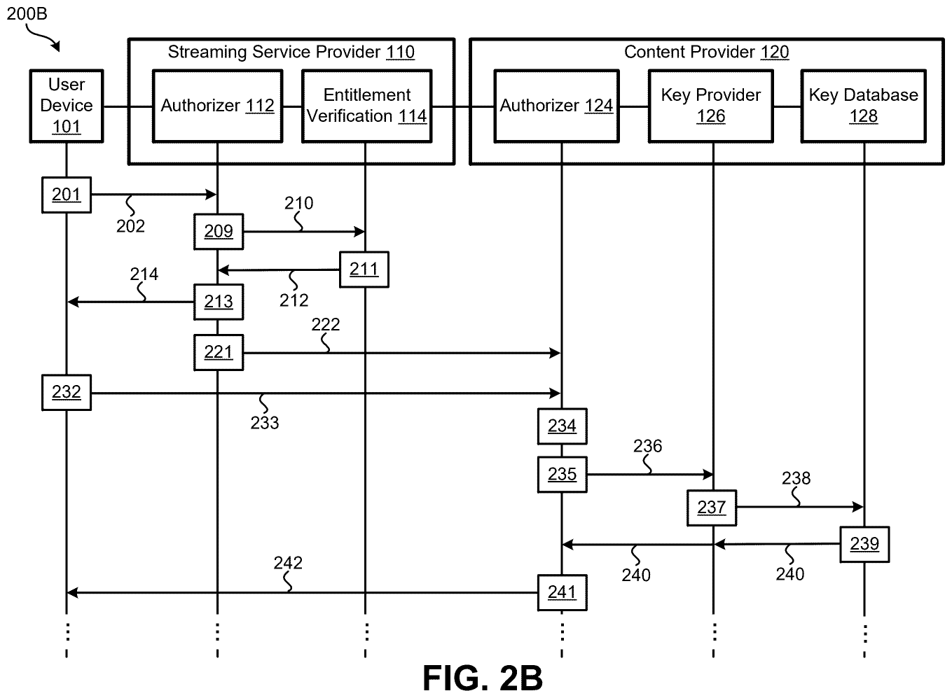

FIGS. 2A-2B are message flow diagrams respectively illustrating example processes for providing streaming services and user/access authentication, according to various embodiments of the present disclosure. FIG. 2A illustrates an example of flow process 200A. Process 200A may commence when a user operating a user device 101 activates a player 104 on the user device 101 to initiate a streaming session to consume multimedia content of a target content item within the streaming session. For example, user device 101 may generate (FUNCTION 201) a request for authentication and send the request (TRANSMISSION 202) to the authorizer 112 of the streaming service provider system 110. The request for authentication may include user authentication information (e.g., including a user ID, a user device ID, user credentials, other user authentication information, information about the target content item by the user, etc.)

Upon receiving the request for authentication, the authorizer 112 may analyze the request (FUNCTION 203) to determine whether the target content item is a DRM-protected item. If the target content item is determined to be a DRM-protected item, the authorizer 112 further identify (FUNCTION 203) the content provider that provides the DRM-protected item requested by the user. The authorizer 112 may generate (FUNCTION 205) a request for playlist and stream control file and send the request (TRANSMISSION 206) to the content manager 116 of the streaming service provider system 110. The content manager 116 may generate (FUNCTION 207) a response including the playlist and stream control file associated with the target content item and send (TRANSMISSION 208) it to the authorizer 112 and the user device 101.

The authorizer 112 generates (FUNCTION 209) a request for entitlement verification and sends (TRANSMISSION 210) the request to the entitlement verification component 114 of the streaming service provider system 110. The request includes the user authentication information, information about the target content item by the user, and information about the content provider. The entitlement verification component 114 performs (FUNCTION 211) an entitlement verification process to determine whether the user is entitled to streaming the target DRM-protected content item provided by the content provider, based on the user authentication information, content provider information, the information about the DRM-protected content item, and predetermined entitlement policies. Upon successful completion of entitlement verification, the entitlement verification component 114 generates (FUNCTION 211) a notification indicating that the user is entitled to the target content item and sends (TRANSMISSION 212) the notification to the authorizer 112.

Upon receipt of the notification, the authorizer 112 generates (FUNCTION 213) a token and send (TRANSMISSION 214) the token to the user device 101. The user device 101 generates (FUNCTION 215) a request for manifest file and sends (TRANSMISSION 216) the request to the dynamic manifest provider 118 of the streaming service provider system 110. In response, the dynamic manifest provider 118 generates (FUNCTION 217) manifest files including a master manifest file and sequential variant manifest files and sends (TRANSMISSION 218) the manifest files to the user device 101. In some embodiments, the user device 101 periodically sends request for variant manifest files (e.g., once every 2 seconds), and the dynamic manifest provider 118 in response periodically generates variant manifest files and sequentially sends them to the user device 101. The manifest files include URLs to the target content item. For example, each variant manifest file may include one or more URLs directed to the location of the content segments of the DRM-protected content item request by the user.

Upon receipt of the manifest files, the user device generates (FUNCTION 219) a request for content segments of the target content item and sends (TRANSMISSION 220) the request to the original content server 132 of the CDN system 130. The request includes the URLs directed to the content segments of the target content item. Upon receiving the request, the original content server 132 locate the content segments of the target content item based on the URLs and delivers (TRANSMISSION 222) the content segments to the user device 101 or allows the user device 101 to fetch the content segments from the original server via the CDN system 130. The content segments may be stored in a temporary memory of the user device. The content segments of the target content item are encrypted if the target content item is DRM-protected.

Simultaneously or immediately after receiving the encrypted content segments (e.g., the initial content segments of the target content item), the user device 101 generates (FUNCTION 223) a request for license and sends (TRANSMISSION 224) the request to the content provider 120. The request includes the token generated by the authorizer 112. The token includes the obfuscated user authentication information and the information about the target DRM-protected content item. The content provider 120 may perform (FUNCTION 225) an authentication process. The authentication process may include analyzing the token and obtain the original user authentication information from the obfuscated user authentication information, authenticating/verifying the user based on the original user authentication information, and generate a response upon successful completion of user authentication. The response may indicate that the user is authorized to access the target content item. The response may further include a decryption key to the DRM-protected content item. The content provider 120 sends (TRANSMISSION 226) the response to the user device 101. The user device 101 decrypts (FUNCTION 227) the encrypted content segments using the encryption key and begins playback of the content segments of the DRM-protected content item.

FIG. 2B illustrates an example of flow process 200B. Flow process 200B shows message flow among the user device 101, the authorizer 112 of the streaming service provider system 110, the authorizer 124 of the content provider system 120, the key provider 126 of the content provider system 120, and the key database 128 of the content provider system 120. The user device 101 may generate (FUNCTION 201) a request for authentication and send the request (TRANSMISSION 202) to the authorizer 112 of the streaming service provider system 110. The authorizer 112 generates (FUNCTION 209) a request for entitlement verification and sends (TRANSMISSION 210) the request to the entitlement verification component 114 of the streaming service provider system 110. The entitlement verification component 114 performs (FUNCTION 211) an entitlement verification process to determine whether the user is entitled to streaming the target DRM-protected content item. Upon successful completion of entitlement verification, the entitlement verification component 114 generates (FUNCTION 211) a notification indicating that the user is entitled to the target content item and sends (TRANSMISSION 212) the notification to the authorizer 112. Upon receipt of the notification, the authorizer 112 generates (FUNCTION 213) a token and send (TRANSMISSION 214) the token to the user device 101.

The authorizer 112 generates (FUNCTION 221) a public-private key pair using a cryptographic algorithm such as RSA and sends (TRANSMISSION 222) the private key to the authorizer 124 of the content provider 120. The public key is shared with the streaming service provider system 110 for encrypting the user authentication information, while the private key is kept confidential by the content provider 120. Upon authentication and entitlement verification, the authorizer 112 of the streaming service provider system 110 constructs (FUNCTION 213) the token containing obfuscated user authentication information. For example, the authorizer 112 encrypts the original user authentication information using the public key, and only the content provider, with access to the corresponding private key, can decrypt and access the original user authentication information from the token.

It should be noted that the encryption-decryption process described above is only an exemplary method for obfuscating the user authentication information. Other techniques such as tokenization-detokenization, hashing, salting and hashing, and data masking are also possible within the scope of the present disclosure. For example, the authorizer 112 can store the user authentication information in a database, assign a hashed value to the user authentication information, generate a token based at least in part on the hashed value, and provide access to the user authentication information to the content provider based at least in part on the hashed value. For another example, the authorizer 112 can generate a token vault containing the original user authentication information. The token vault is stored securely in a database of the streaming service provider 110. The authorizer 112 generates a token containing obfuscated user authentication information corresponding to the original user authentication information stored in the dedicated token vault and sends the token to the content provider 120. Upon receiving the token, the authorizer 124 of the content provider 120 performs a detokenization process to extract the original user authentication information from the token. For example, the authorizer 124 may access the token vault or database that stores the mapping between the token and the original user authentication information, process the retrieved original user authentication information to authenticate the user, and provide the user device with access to the requested content when the user is authenticated.

Similarly, the steaming service provider 110 may apply a hash function to the original user authentication information, store the hashed value securely in the database, generate a token containing the hashed value, and send the token to the content provider 120. Upon receiving the token, the authorizer 124 of the content provider 120 may extract the hashed value from the token and perform a lookup using the hashed value to verify the user authentication information. For example, the authorizer 124 may query the database of the streaming service provider 120, locate the token vault in the database, and verify the hashed user ID or device ID. The database contains the mappings of hashed user ID or device ID to the original user authentication information. If the hashed user ID is found in the database, the user is verified, and the original user information is retrieved. If the token includes masked data, the authorizer 124 may verify the masked data by cross-referencing the masked data with the stored original data in the vault.

The authorizer 112 generates (FUNCTION 232) the token and transmits (TRANSMISSION 233) the token to the authorizer 124 of the content provider 120. In some embodiments, the transmission of the token is over a trusted communication channel, using transport layer security protocols such as HTTPS or TLS. The authorizer 124 of the content provider 120 receives the token and decrypts the encrypted obfuscated user authentication information using the private key of the predetermined public-private key pair. The decryption process reveals the original user authentication information. The authorizer 124 of the content provider 120 verifies (FUNCTION 234) the integrity and authenticity of the token. This may involve validating digital signatures or performing additional integrity checks to ensure that the token has not been tampered with during transmission. Based on the decrypted token contents, the authorizer 124 of the content provider 120 grants or denies access to the requested DRM-protected content.

Upon successful authentication of the user, the authorizer 124 generates (FUNCTION 235) a request for a decryption key and sends (TRANSMISSION 236) the request to the key provider 126 of the content provider 120. The key provider 126 generates (FUNCTION 237) a request to retrieve the decryption key and sends the request to the key database 128 of the content provider 120. The key database locates (FUNCTION 239) the decryption key and sends (TRANSMISSION 240) the decryption key to the key provider 126 and the authorizer 124. Upon receiving the decryption key, the authorizer 124 generates (FUNCTION 241) a secured blob including the encryption key and sends the secured blob to the user device 101. The user device 101 may extract the decryption key from the secured blob and decrypt the content segments of the DRM-protected content item using the decryption key to stream the content on the player 104.

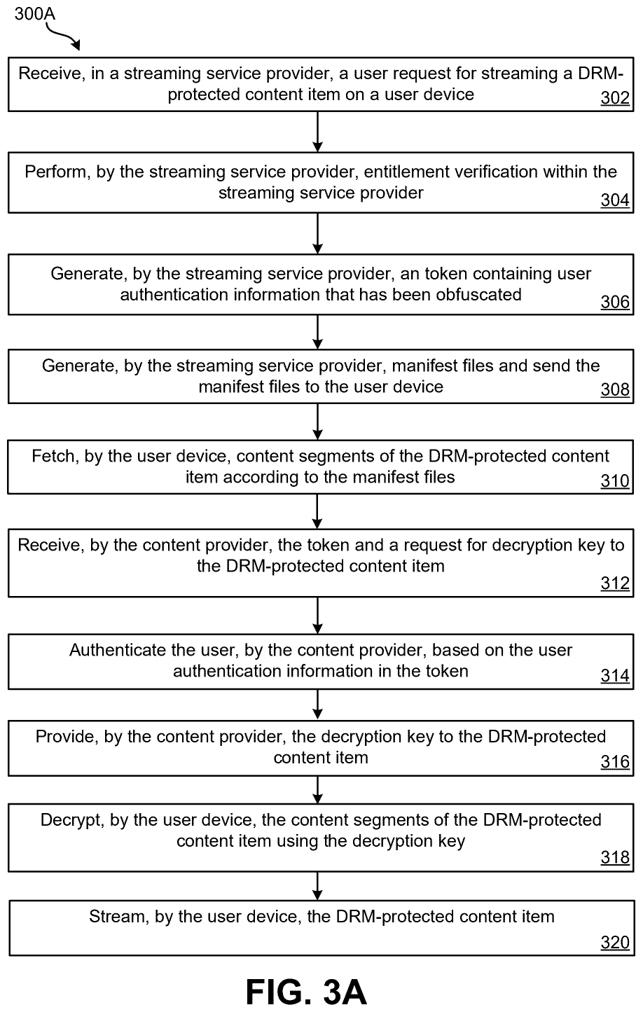

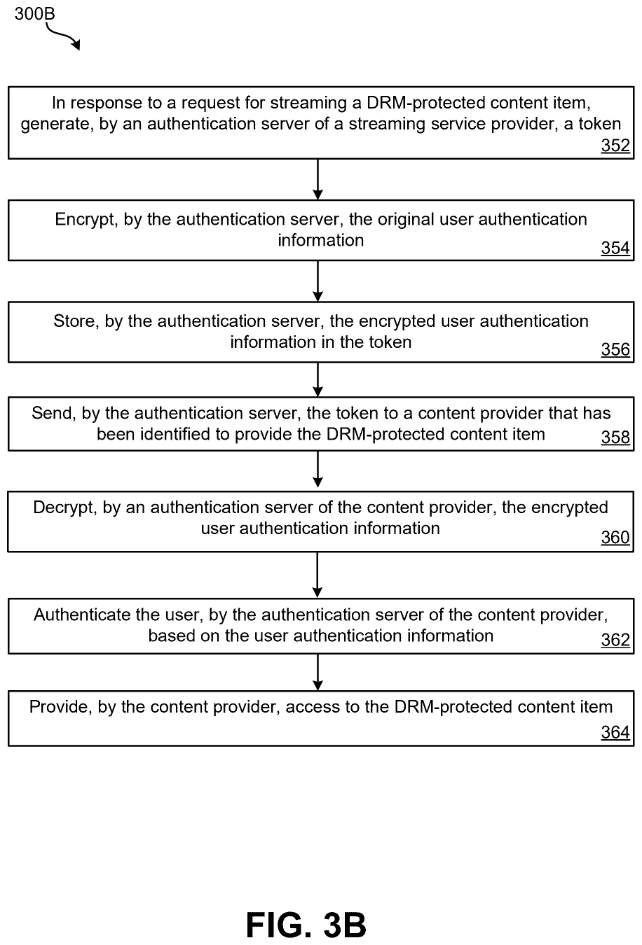

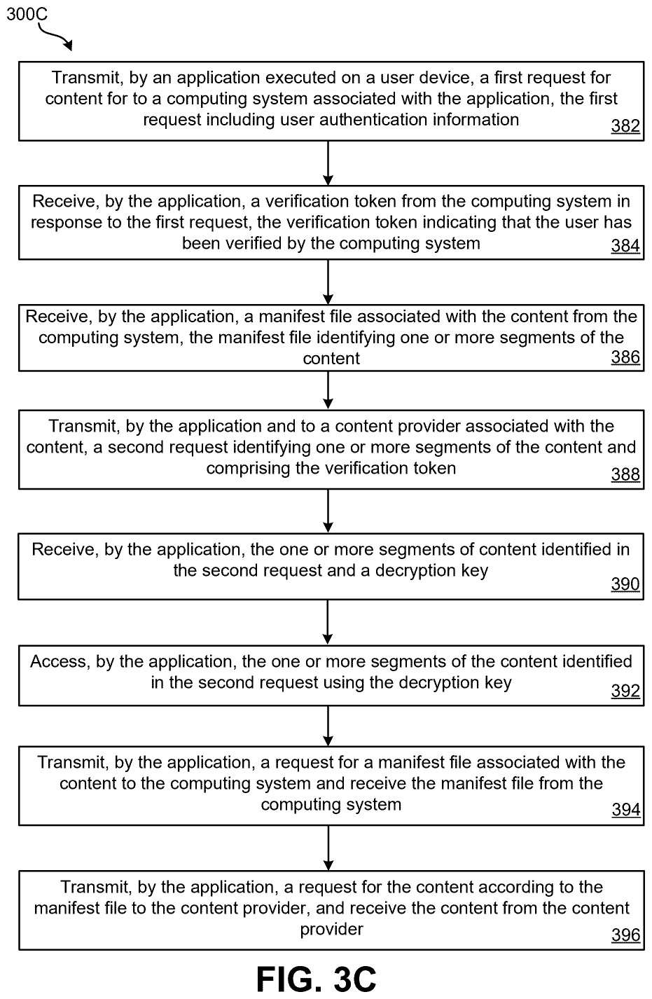

FIGS. 3A-3C are flow diagrams respectively illustrating example methods 300A, 300B, and 300C for user authentication. Methods 300A, 300B, and 300C may be performed by the media streaming system 100 or any component thereof, such as the streaming service provider 110, content provider 120, user device 101, etc. FIG. 3A illustrates method 300A. In the illustrated example, method 300A may include process blocks 302-320. Few or additional process blocks may be included. The process blocks of method 300A may be combined with process blocks of another method described herein in any suitable manner.

At 302, a user request for streaming a content item on a user device is sent to and received by a first authentication server (e.g., authorizer 112) of a streaming service provider. The request includes user authentication information and content information. The user authentication information further includes a user ID, a user device ID, user credential information, user status information, user account information, among others. At 304, an entitlement verification process is performed within the streaming service provider. The entitlement verification process includes determining if the target content item is a DRM-protected content item based on the content information, identifying a content provider that provides the DRM-protected content item, determining whether the user is authorized to stream the content item, and/or determining whether the user is entitled to the DRM-protected content item based on user authentication information.

At 306, upon successful entitlement verification, a token is generated by the first authorization server of the streaming service provider. In some embodiments, the user authentication information provided by the user is obfuscated by the authentication server and included in the token. At 308, manifest files are generated by a dynamic manifest provider of the streaming service provider and sent to the user device. The manifest files may include a master manifest file and a series of variant manifest files. The master manifest file includes references or URLs to the variant manifest files, each representing a different version of the content at specific bitrates or resolutions. The variant manifest files respectively correspond to a series of requests sent from the user device. Each variant manifest file includes a playlist of sequential content segments of the target content item for streaming within a specified timeframe and URLs to the content segments. At 310, the content segments are fetched by the user device following the URLs. The content segments may be encrypted by the content provider.

At 312, a request for license to access the content segments of the target content item is received in a second authentication server (e.g., authorizer 124) of the content provider. The request includes the token generated by the first authentication server. At 314, an authentication process is performed by the second authentication server to determine whether the user is authorized to access the target content item. The authentication process may include extracting the user authentication information that has been obfuscated from the token and authenticating the user based on the user authentication information.

At 316, upon successful authentication of the user, a decryption key to the content segments is provided to the user device by the second authentication server of the content provider. At 318, the content segments are decrypted by the user device using the decryption key. At 320, the content segments of the target content item are streamed on the player of the user device.

FIG. 3B illustrates method 300B. In the illustrated example, method 300B may include process blocks 352-364. Few or additional process blocks may be included. The process blocks of method 300B may be combined with process blocks of another method described herein in any suitable manner.

At 352, a token is generated, by a first authentication server of the streaming service provider, in response to a request for streaming a DRM-protected content item from a user. The request includes original user authentication information and content information about the DRM-protected content item. At 354, the original user authentication information is encrypted, by the first authentication server. At 356, the encrypted user authentication information is stored in the token. In some embodiments, the original user authentication information is encrypted using the public key of a predetermined public-private key pair. In some embodiments, the original user authentication information is encrypted using a hashing technique, a hashed value mapped to the original user authentication information is generated and assigned to a token vault, the original user authentication information is stored in the token vault, and the token vault is stored in a database associated with the streaming service provider. In some embodiments, the original user authentication information is encrypted by applying a mask to the original user authentication information, and the masked user authentication information is stored in the token.

At 358, the token is sent to and received by a second authentication server of a content provider that has been identified to provide the DRM-protected content item. At 360. The encrypted user authentication information is decrypted by the second authentication server. In some embodiments, the encrypted user authentication information is decrypted using the private key of the predetermined public-private key pair. In some embodiments, the database is accessed by the second authentication server to locate the token vault and access the original user authentication information mapped to the token vault. In some embodiments, a lookup is performed using the hashed value stored in the token to verify the user authentication information based on the predetermined mapping between the hashed value and the original user authentication information. In some embodiments, a lookup is performed to verify the masked user authentication information by cross-referencing the masked user authentication information with the original user authentication information stored in the vault.

At 362, a user authentication process is performed by the second authentication server to determine whether the user is authorized to access the DRM-protected content item, based on the original user authentication information obtained from decryption, the content information of the DRM-protected content item, and a predetermined policy. At 364, upon successful authentication, access to the DRM-protected content item is granted and provided to the user device. For example, a decryption key to the encrypted content segments of the DRM-protected content item is generated and provided to the user device for the user device to decrypt the stream the content segments.

FIG. 3C illustrates method 300C. In the illustrated example, method 300C may include process blocks 382-396. Few or additional process blocks may be included. The process blocks of method 300C may be combined with process blocks of another method described herein in any suitable manner.

At 382, an application executed on the user device causes the user device to transmit a first request for content to a computing system (e.g., a streaming service provider) associated with the application, the first request includes user authentication information.

At 384, the application is executed to cause the user device to receive a verification token from the computing system in response to the first request, the verification token indicating that the user has been verified by the computing system.

At 386, the application is executed to cause the user device to receive a manifest file associated with the content from the computing system, the manifest file identifying one or more segments of the content.

At 388, the application is executed to cause the user device to transmit a second request to a content provider associated with the content, a second request identifying one or more segments of the content and comprising the verification token.

At 390, the application is executed to cause the user device to receive the one or more segments of content identified in the second request and a decryption key.

At 392, the application is executed to cause the user device to access the one or more segments of the content identified in the second request using the decryption key.

At 394, the application is executed to cause the user device to fetch a manifest file associated with the content from the computing system. In some embodiments, the application is executed to cause the user device to send a request for a manifest file to the computing system and retrieve the manifest file from a database associated with the computing system upon approval of the request.

At 396, the application is executed to cause the user device to fetch the content from the content provider according to the manifest files. In some embodiments, the application is executed to cause the user device to send a request for the content to the content provider and retrieve one or more segments of the content from a content server associated with the content provider according to the URLs included in the manifest file upon approval of the request.

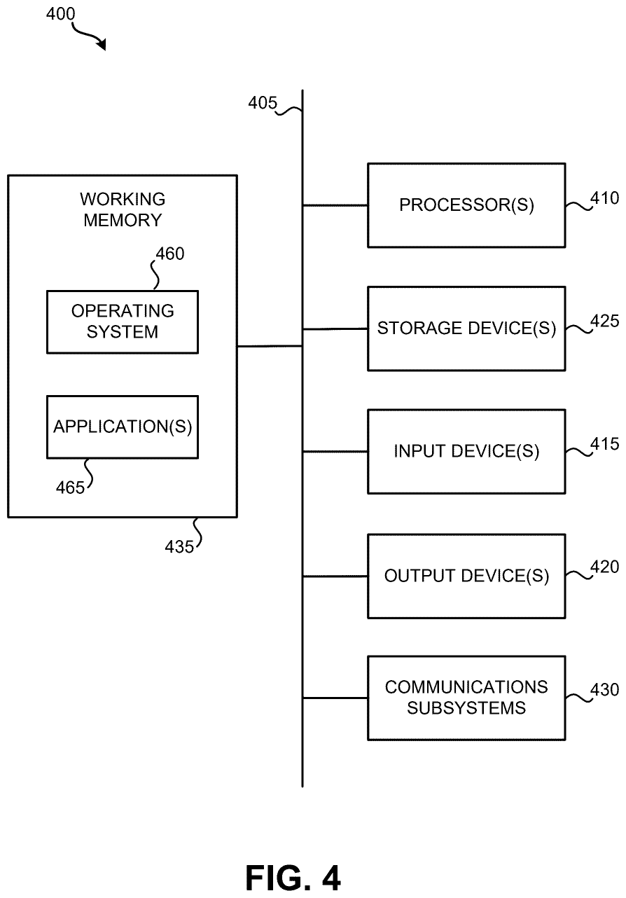

The media streaming system 100 or any components thereof, such as the user device 101, streaming service provider system 110, content provider system 120, the CDN system 130, etc., described above may include a computer system (or computing system or computing device) that further includes computer hardware and software that form special-purpose network circuitry to implement various embodiments such as communication, generation of data, determination, identification, calculation, performing a process, and other operations or steps of the methods or processes described herein. FIG. 4 is a schematic diagram illustrating an example of computer system 400. The computer system 400 is a simplified computer system that can be used to implement various embodiments described and illustrated herein. FIG. 4 provides a schematic illustration of one embodiment of a computer system 400 that can perform some or all of the steps of the methods and workflows provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown including hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 425, which can include, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, a 802.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g., the first electronic device, may be incorporated into the computer system 400, e.g., an electronic device as an input device 415. In some embodiments, the computer system 400 will further include a working memory 435, which can include a RAM or ROM device, as described above.

The computer system 400 also can include software elements, shown as being currently located within the working memory 435, including an operating system 460, device drivers, executable libraries, and/or other code, such as one or more application programs 465, which may include computer programs provided by various embodiments, and/or may be designed to implement methods, and/or configure systems, provided by other embodiments, as described herein. Merely by way of example, one or more procedures described with respect to the methods discussed above, such as those described in relation to FIG. 4, might be implemented as code and/or instructions executable by a computer and/or a processor within a computer; in one embodiment, then, such code and/or instructions can be used to configure and/or adapt a general purpose computer or other device to perform one or more operations in accordance with the described methods.

A set of these instructions and/or code may be stored on a non-transitory computer-readable storage medium, such as the storage device(s) 425 described above. In some cases, the storage medium might be incorporated within a computer system, such as computer system 400. In other embodiments, the storage medium might be separate from a computer system e.g., a removable medium, such as a compact disc, and/or provided in an installation package, and the storage medium can be used to program, configure, and/or adapt a general-purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, some embodiments may employ a computer system such as the computer system 400 to perform methods in accordance with various embodiments of the technology. According to a set of embodiments, some or all of the operations of such methods are performed by the computer system 400 in response to processor 410 executing one or more sequences of one or more instructions, which might be incorporated into the operating system 460 and/or other code, such as an application program 465, contained in the working memory 435. Such instructions may be read into the working memory 435 from another computer-readable medium, such as one or more of the storage device(s) 425. Merely by way of example, execution of the sequences of instructions contained in the working memory 435 might cause the processor(s) 410 to perform one or more procedures of the methods described herein. In one embodiment, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many implementations, a computer-readable medium is a physical and/or tangible storage medium. Such a medium may take the form of a non-volatile media or volatile media. Non-volatile media include, for example, optical and/or magnetic disks, such as the storage device(s) 425. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may, in one embodiment, be stored on a non-transitory storage device 425 either before or after execution by the processor(s) 410.

The methods, systems, and devices discussed above are examples. Various configurations may omit, substitute, or add various procedures or components as appropriate. For instance, in some embodiments, the methods may be performed in an order different from that described, and/or various stages may be added, omitted, and/or combined. Also, features described with respect to certain configurations may be combined in various other configurations. Various embodiments of the configurations may be combined in a similar manner. Also, technology evolves and, thus, many of the elements are examples and do not limit the scope of the disclosure or claims.

Specific details are given in the description to provide a thorough understanding of exemplary configurations including implementations. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide an enabling description for implementing described techniques. Various changes may be made in the function and arrangement of elements without departing from the embodiments of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

As used herein and in the appended claims, the singular forms “a”, “an”, and “the” include plural references unless the context clearly dictates otherwise. Thus, for example, reference to “a segment” includes a plurality of such segments, and reference to “the processor” includes reference to one or more processors and equivalents thereof known in the art, and so forth.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

Having described several example configurations, various modifications, alternative constructions, and equivalents may be used without departing from the spirit of the disclosure. For example, the above elements may be components of a larger system, wherein other rules may take precedence over or otherwise modify the application of the disclosure. Also, a number of steps may be undertaken before, during, or after the above elements are considered.

What is claimed is:

1. A computing system comprising:
one or more processors; and
a computer-readable storage media comprising instructions that, when executed by the one or more processors, cause the computing system to:
receive, by the computing system, a request for content from an application executed on a user device, the request including user authentication information;
verify, by the computing system, the user device based at least in part on the user authentication information;
generate, by the computing system, a token including user authentication information;
generate, by the computing system, a manifest file associated with the content; and
transmit, by the computing system, the manifest file and the token to the application executed on the user device.

2. The computing system of claim 1, wherein the application on executed on user device transmits the token to a content provider associated with the content.

3. The computing system of claim 2, wherein the application executed on the user device receives a decryption key generated by the content provider and accesses the content using the decryption key.

4. The computing system of claim 3, wherein the decryption key is received by the application executed on the user device as a secured blob generated by the content provider.

5. The computing system of claim 1, wherein the computer-executable instructions further cause the system to:
determine, by the computing system, that the content is encrypted using a digital right management (DRM) key.

6. The computing system of claim 1, wherein the user authentication information comprises at least one of a user ID, a user device ID, or user credentials associated with the user ID.

7. The computing system of claim 1, wherein the computer-executable instructions when executed further cause the computing system to:
encrypt, by the computing system, the user authentication information using a public key of a public-private key pair such that the user authentication information is obfuscated.

8. The computing system of claim 2, wherein the computer-executable instructions when executed further cause the computing system to:
store, by the computing system, the user authentication information in a database;
assign, by the computing system, a hashed value to the user authentication information;
generate, by the computing system, the token based at least in part on the hashed value; and
provide, by the computing system, access to the user authentication information to the content provider based at least in part on the hashed value.

9. The computing system of claim 1, wherein the manifest file comprises a master manifest file and a series of variant manifest files, the master manifest file comprises universal resource locators (URLs) respectively corresponding to the series of variant manifest files.

10. The computing system of claim 9, wherein each one of the variant manifest files comprises URLs to one or more content segments of the content.

11. A method, comprising:
receiving, by a computing system, a request for content from an application executed on a user device, the request including user authentication information;
verifying, by the computing system, the user device based at least in part on the user authentication information;
generating, by the computing system, a token including user authentication information;
generating, by the computing system, a manifest file associated with the content; and
transmitting, by the computing system, the manifest file and the token to the application executed on the user device.

12. The method of claim 11, wherein the application on executed on user device transmits the token to a content provider associated with the content.

13. The method of claim 12, wherein the application executed on the user device receives a decryption key generated by the content provider and accesses the content using the decryption key.

14. The method of claim 11, wherein the user authentication information comprises at least one of a user ID, a user device ID, or user credentials associated with the user ID.

15. The method of claim 11, further comprising:
encrypting, by the computing system, the user authentication information using a public key of a public-private key pair such that the user authentication information is obfuscated.

16. The method of claim 12, further comprising:
storing, by the computing system, the user authentication information in a database;
assigning, by the computing system, a hashed value to the user authentication information;
generating, by the computing system, the token based at least in part on the hashed value; and
providing, by the computing system, access to the user authentication information to the content provider based at least in part on the hashed value.

17. A non-transitory computer-readable medium comprising instructions that, when executed by one or more processors, cause the one or more processors to perform operations comprising:
receiving, by a computing system, a request for content from an application executed on a user device, the request including user authentication information;
verifying, by the computing system, the user device based at least in part on the user authentication information;
generating, by the computing system, a token including user authentication information;
generating, by the computing system, a manifest file associated with the content; and
transmitting, by the computing system, the manifest file and the token to the application executed on the user device.

18. The non-transitory computer-readable medium of claim 17, wherein the application on executed on user device transmits the token to a content provider associated with the content.

19. The non-transitory computer-readable medium of claim 18, wherein the application executed on the user device receives a decryption key generated by the content provider and accesses the content using the decryption key.

20. The non-transitory computer-readable medium of claim 17, wherein the operations further comprise:
encrypt, by the computing system, the user authentication information using a public key of a public-private key pair such that the user authentication information is obfuscated.
